(19) United States
(12) Patent Application Publication
(10) Pub. No.: US 2024/0076927 A1
(43) Pub. Date: Mar. 7, 2024

(54) WINDOW REGULATOR

(71) Applicant: AISIN CORPORATION, Kariya (JP)

(72) Inventors: Kenji YAMAMOTO, Kariya-shi (JP); Masanao BABA, Kariya-shi (JP); Satoshi ISAZAWA, Kariya-shi (JP)

(73) Assignee: AISIN CORPORATION, Kariya (JP)

(21) Appl. No.: 18/350,079

(22) Filed: Jul. 11, 2023

(30) Foreign Application Priority Data
Sep. 2, 2022 (JP) 2022-139938
Apr. 11, 2023 (JP) 2023-064110

(51) Int. Cl. E05F 15/689

(52) U.S. Cl. CPC E05F 15/689; E05Y 2201/624; E05Y 2201/712; E05Y 2900/55

(57) ABSTRACT

A window regulator includes: a base assembled to a vehicle; a bracket configured to support window glass; an arm member having one end side rotatably supported by the base and the other end side rotatably supported by the bracket; and a driving member configured to drive, by rotationally driving the arm member, the bracket configured to support the window glass. At least one of a rotation center axis on the one end side of the arm member and a rotation center axis on the other end side of the arm member is inclined in a vehicle front-rear direction with respect to a vehicle width direction when viewed from a vehicle upper-lower direction.

### CROSS REFERENCE TO RELATED APPLICATIONS

This application is based on and claims priority under 35 U.S.C. § 119 to Japanese Patent Application 2022-139938, filed on Sep. 2, 2022 and Japanese Patent Application 2023-064110, filed on Apr. 11, 2023, the entire content of which is incorporated herein by reference.

### TECHNICAL FIELD

This disclosure relates to a window regulator.

### BACKGROUND DISCUSSION

JP H06-26264A (Reference 1) discloses an arm-type window regulator device that raises and lowers window glass of an automobile. In this window regulator device, a door inner panel is disposed inward of a door outer panel of a vehicle body in a vehicle width direction, and a side beam is disposed between the door outer panel and the door inner panel along a front-rear direction of the vehicle body on the door outer panel. A guide rail that transfers the window glass is provided between the door outer panel and the door inner panel along the front-rear direction of the vehicle body, and a link that is movably engaged in a longitudinal direction in the guide rail is provided. Each of one end portion and a portion adjacent to the one end portion of the link is movably engaged with the guide rail, and a base plate is disposed on the door inner panel. A main arm is swingably provided on the base plate, and a sub arm parallel to the main arm is swingably provided on the side beam. A tip end portion of the main arm is pivotably connected to the link, and a tip end portion of the sub arm is pivotably connected to the link.

However, the window regulator device according to Reference 1 has a problem that an undesirable force acts on the window glass due to a deviation between a raising and lowering trajectory of the window glass and driving trajectories of the main arm and the sub arm, and that smooth raising and lowering is inhibited.

A need thus exists for a window regulator which is not susceptible to the drawback mentioned above.

### SUMMARY

According to an aspect of this disclosure, a window regulator includes: a base assembled to a vehicle; a bracket configured to support window glass; an arm member having one end side rotatably supported by the base and the other end side rotatably supported by the bracket; and a driving member configured to drive, by rotationally driving the arm member, the bracket configured to support the window glass. At least one of a rotation center axis on the one end side of the arm member and a rotation center axis on the other end side of the arm member is inclined in a vehicle front-rear direction with respect to a vehicle width direction when viewed from a vehicle upper-lower direction.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a view illustrating a fully open position, a fully closed position, and an intermediate position of a window regulator as viewed from a vehicle width direction;

FIG. 2 is an exploded perspective view of components of the window regulator;

FIG. 3 is a view illustrating the fully closed position of the window regulator as viewed from the vehicle width direction;

FIGS. 4A to 4C are cross-sectional views taken along lines 4A-4A, 4B-4B, and 4C-4C in

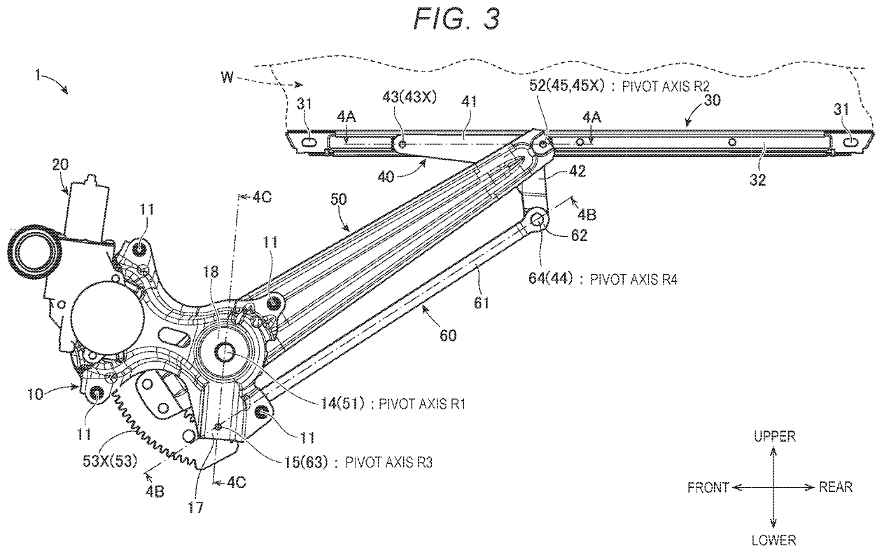

FIG. 3;

FIG. 5 is an enlarged view illustrating a single structure of a base;

FIGS. 6A to 6E are cross-sectional views taken along lines 6A-6A, 6B-6B, 6C-6C, 6D-6D, and 6E-6E in FIG. 5;

FIG. 7A is an enlarged view illustrating a single structure of a first arm, and FIG. 7B is a cross-sectional view taken along a line 7B-7B in FIG. 7A;

FIG. 8A is an enlarged view illustrating a single structure of a second arm, and FIG. 8B is a cross-sectional view taken along a line 8B-8B in FIG. 8A;

FIG. 9A is an enlarged view illustrating a single structure of a bell crank, FIG. 9B is a cross-sectional view taken along a line 9B-9B in FIG. 9A, and FIG. 9C is a cross-sectional view taken along a line 9C-9C in FIG. 9A;

FIG. 10 is a view of the window regulator as viewed from an upper-lower direction;

FIGS. 11A and 11B are views illustrating superiority attained by a bent portion according to the present embodiment; and

FIG. 12 is a view illustrating a detailed structure of the bent portion according to the present embodiment.

### DETAILED DESCRIPTION

A “window regulator” defined in the claims is used as a concept including both of a window regulator in a state of being incorporated into an automobile (vehicle) and a window regulator in an assembled (sub-assembled) state before being incorporated into the automobile (vehicle) (both are included in the technical scope of this disclosure). “Rotate” and “pivot” may be replaced with each other (may be synonymous). “Rotation support portion (pivot support portion)” and “rotation center axis (pivot center axis)” may be replaced with each other (may be synonymous). For example, a rotation center (pivot center) of a rotation support portion (pivot support portion) may be referred to as a rotation center axis (pivot center axis).

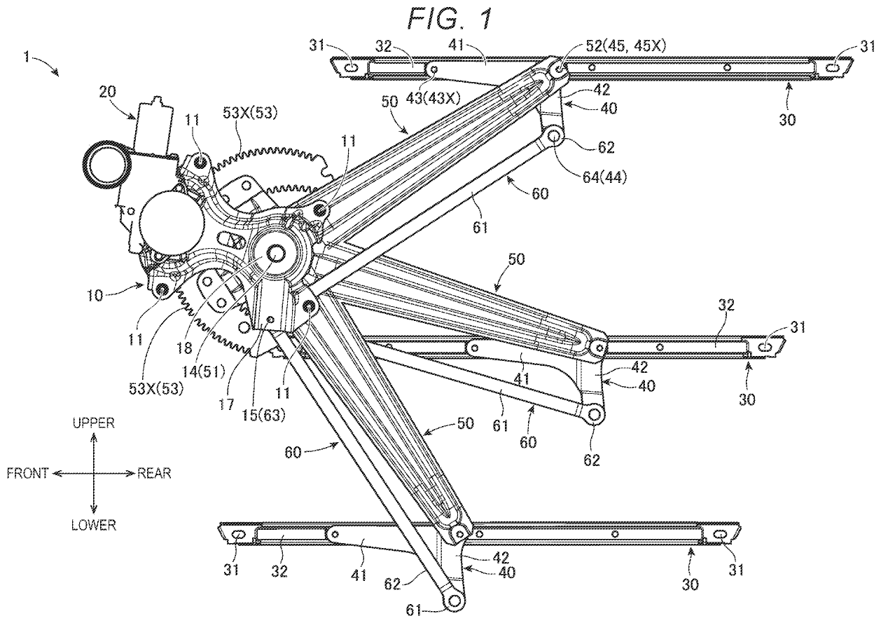

A window regulator 1 according to the present embodiment will be described in detail with reference to FIGS. 1 to 10. An upper-lower direction, a front-rear direction, and a vehicle width direction (vehicle interior-exterior direction) used below will be described with reference to directions of arrows in the drawings. For example, FIGS. 1 and 3 are views as viewed from a vehicle interior side in the vehicle width direction (a front side when viewed on the paper is the vehicle interior side, and a back side when viewed on the paper is a vehicle exterior side). The upper-lower direction may be replaced with a “vehicle upper-lower direction”, and the front-rear direction may be replaced with a “vehicle front-rear direction” (these expressions may be synonymous).

The window regulator 1 according to the present embodiment is mounted inside a door panel at a right front seat (a driver seat when a right steering wheel is used) in an automobile (vehicle) to raise and lower (opens and closes) window glass W at the right front seat (the window glass W is illustrated in FIG. 3). The window regulator 1 may be mounted inside a door panel at a left front seat (a passenger seat when a right steering wheel is used) or a rear seat in an automobile to raise and lower window glass at the seat.

The window regulator 1 includes a base (base plate) 10, a motor unit (driving member) 20, a bracket (lift arm bracket) 30, a bell crank (shoe member) 40, a first arm (main arm, lift arm, and arm member) 50, and a second arm (sub arm, EQ rod, and arm member) 60.

The base 10 is a basic component of the window regulator 1 that directly or indirectly supports the motor unit 20, the bracket 30, the bell crank 40, the first arm 50, the second arm 60, and other various components. The base 10 is assembled to the automobile (vehicle) as a basic component of the window regulator 1 in an assembled (sub-assembled) state (assembled with reference to the base 10). As illustrated in FIG. 5 and the like, the base 10 has insertion holes 11 located at four corners, and is fastened (fastened together) to a door panel (inner panel and outer panel) by four fastening members (not illustrated) that are each inserted into a respective one of the insertion holes 11. That is, the base 10 is assembled to only one of the inner panel and the outer panel of the vehicle. An attachment of the base 10 also includes an attachment to a member attached to the inner panel or the outer panel. The base 10 may be directly or indirectly attached to the inner panel or the outer panel. Further, the base 10 may correspond to a “door-constituting vehicle member”. Further, the base 10 according to the present embodiment is implemented by a single member. Alternatively, the base 10 may be implemented by a member attained by combining (bonding or joining) a plurality of members, or a plurality of members at positions separated from each other. When the base 10 is implemented by the plurality of members at positions separated from each other, one of the plurality of bases may support the first arm, and another one of the plurality of bases may support the second arm.

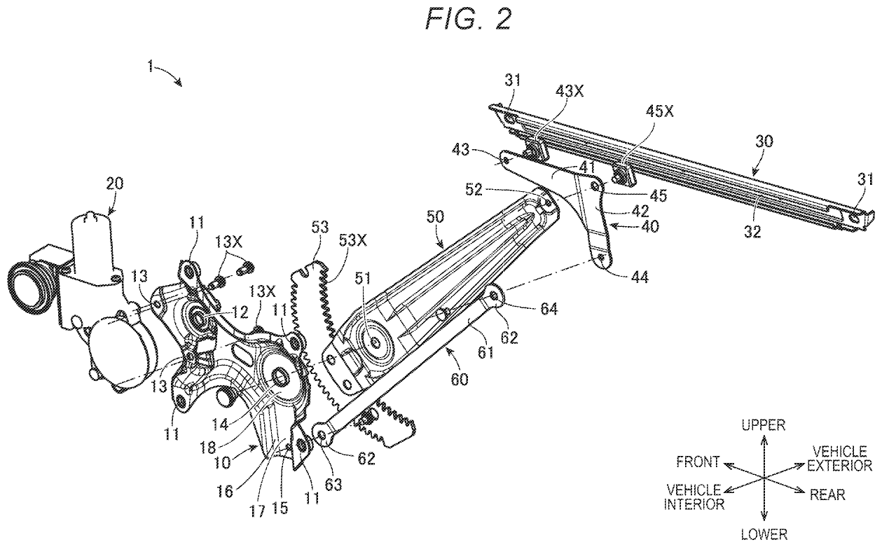

The motor unit 20 includes a motor and a built-in gear mechanism (gear mechanism) that transmits a rotational driving force of the motor to the first arm 50 (a driven gear 53 to be described later). As illustrated in FIGS. 2, 5, and the like, the base 10 has a fitting hole 12 and three insertion holes 13 located around the fitting hole 12. The motor unit 20 is supported by the base 10 (see FIG. 2) by fitting a center axis (for example, a serration shaft) of the built-in gear mechanism of the motor unit 20 into the fitting hole 12, inserting three fastening members 13X into the three insertion holes 13, and fastening the fastening members 13X into fastening holes of the motor unit 20. In this supported state, the rotational driving force of the motor unit 20 is transmitted to the first arm 50 (the driven gear 53 to be described later).

The bracket 30 is a channel member extending in the front-rear direction (extending direction). Two insertion holes 31 are formed on both sides of the bracket 30 in the front-rear direction, and the window glass W (FIG. 3) is supported by the bracket 30 using two fastening members (not illustrated) that are each inserted into a respective one of the two insertion holes 31. A slide rail 32 extending in the front-rear direction is formed at a middle portion of the two insertion holes 31 of the bracket 30, and the bell crank 40 is supported by the slide rail 32 in a manner of being slidable in the front-rear direction (extending direction). The bell crank 40 may be regarded as a part of the bracket 30.

As illustrated in FIGS. 2, 9, and the like, the bell crank 40 is a substantially L-shaped (substantially boomerang-shaped) member including a first side 41 extending in the front-rear direction (an extending direction of the slide rail 32 of the bracket 30) and a second side 42 bent downward (a direction intersecting the extending direction of the slide rail 32 of the bracket 30) from a rear end portion of the bracket 30. A through hole 43 is formed at a front side of the first side 41, a through hole (pivot support hole) 44 is formed at a lower side of the second side 42, and a through hole (pivot support hole) 45 is formed in a connection portion of the first side 41 and the second side 42. Two slider shoes 43X and 45X that are separated from each other in the front-rear direction are supported by the slide rail 32 of the bracket 30 in a manner of being slidable in the front-rear direction, a fitting pin of the slider shoe 43X is fitted into the through hole 43, and a fitting pin of the slider shoe 45X is fitted into the through hole 45. In this manner, the bell crank 40 is supported by the slide rail 32 of the bracket 30 in a manner of being slidable in the front-rear direction (extending direction).

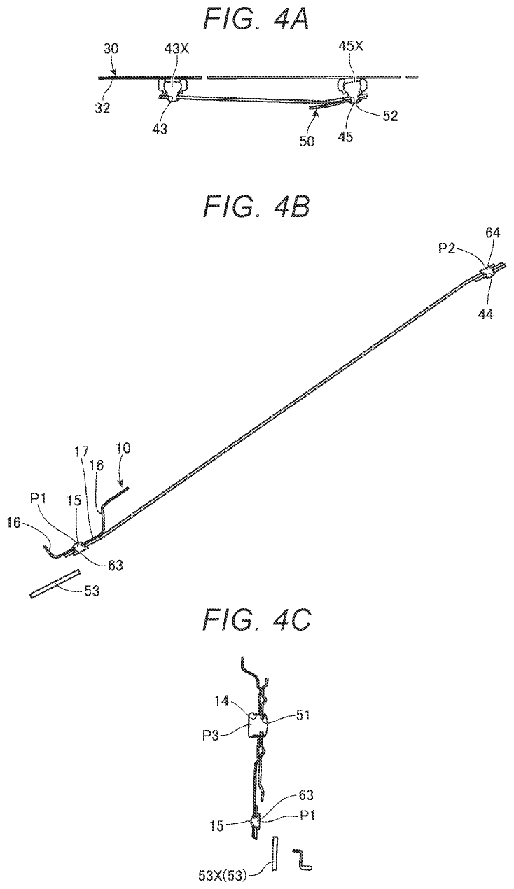

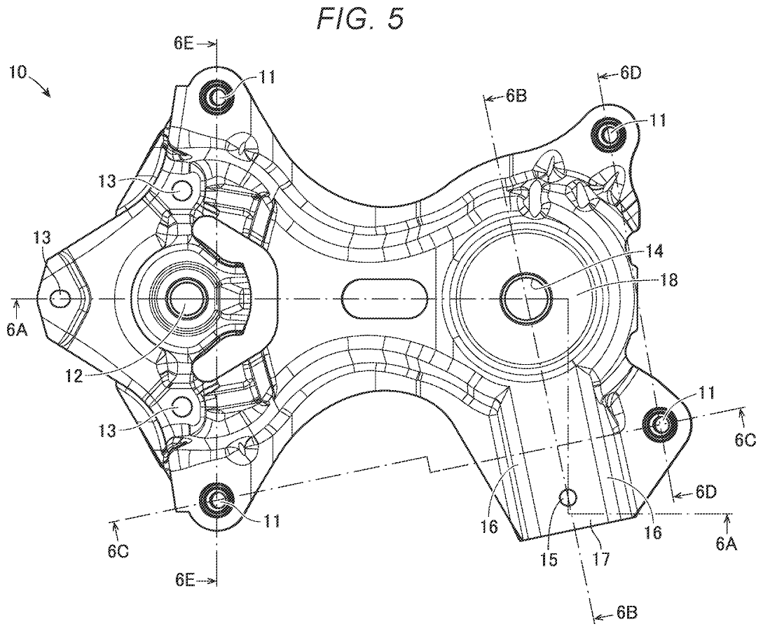

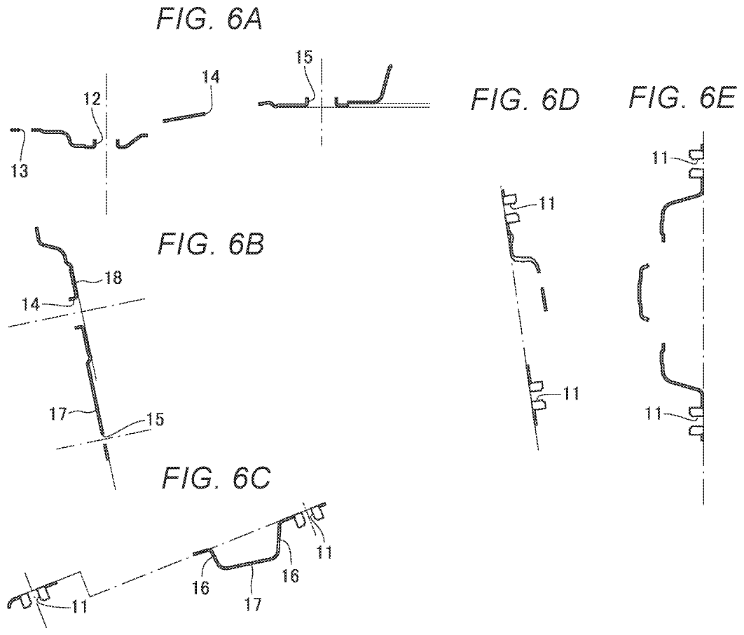

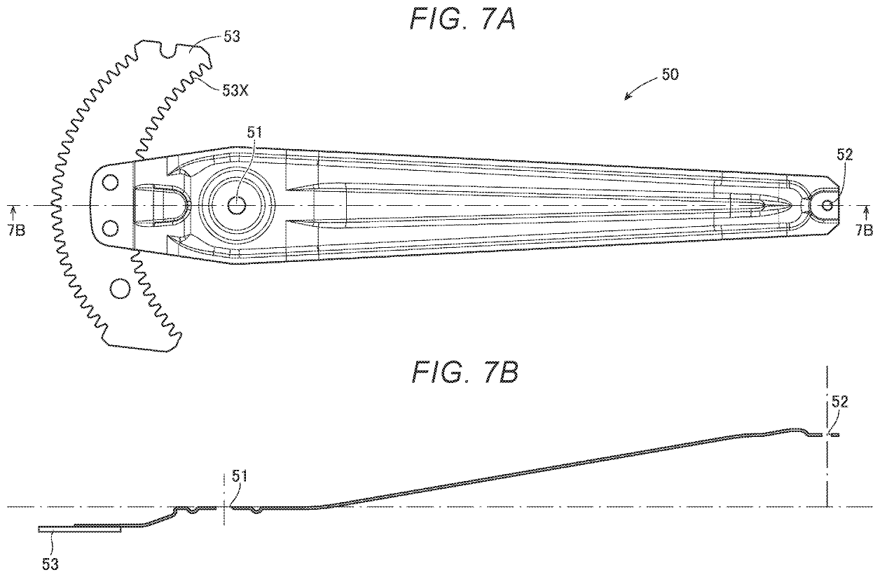

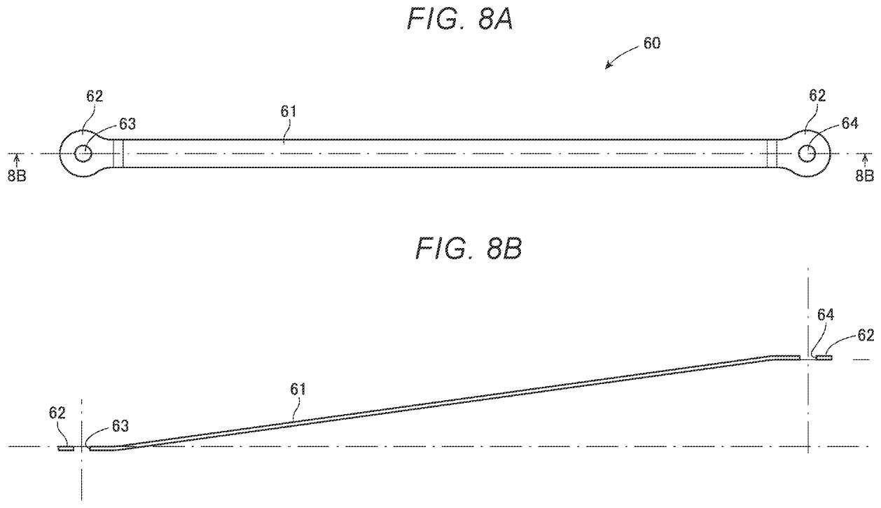

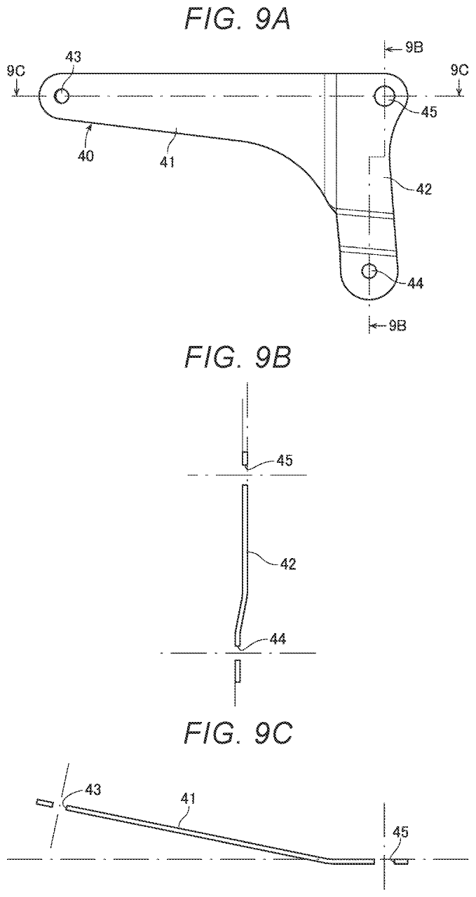

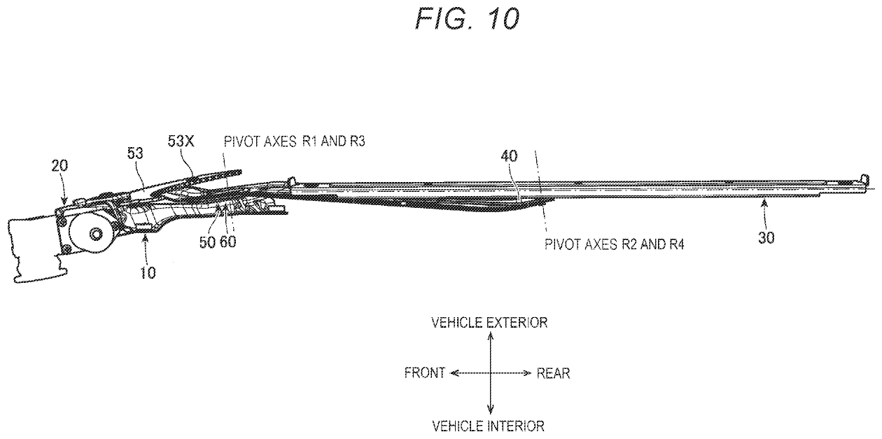

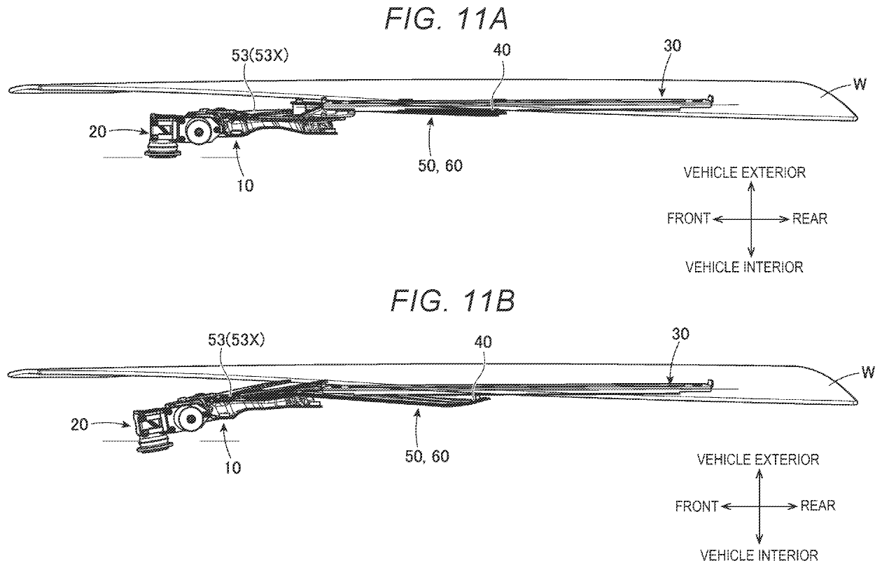

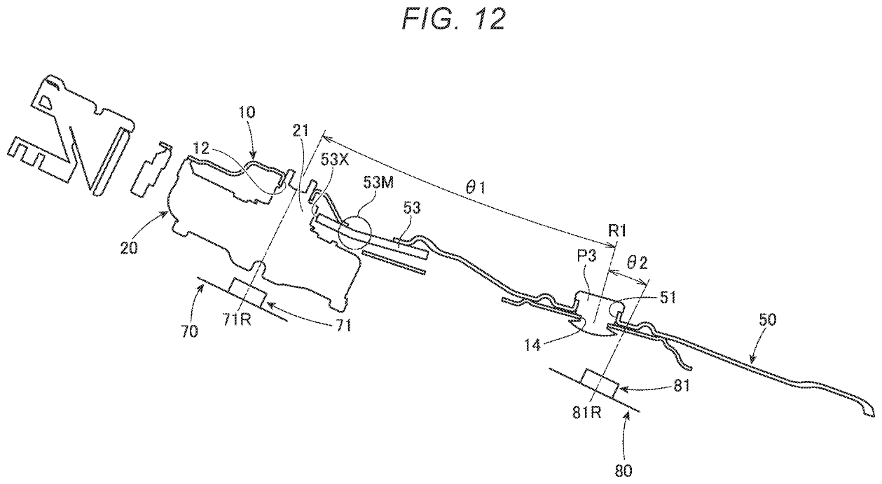

One end side of the first arm 50 is rotatably supported by the base 10, and the other end side of the first arm 50 is rotatably supported by the bracket 30 (bell crank 40). As illustrated in FIG. 2, 7, and the like, a pivot support hole 51 is bored slightly toward the middle from the one end side of the first arm 50, and a pivot support hole 52 is bored at the other end side of the first arm 50. The driven gear 53 is provided on one end side (a tip end side with respect to the pivot support hole 51) of the first arm 50. The driven gear 53 is a gear member having tooth portions (gear mechanism) 53X. As illustrated in FIG. 2, 5, and the like, the base 10 is formed with a pivot support hole 14, and the one end side of the first arm 50 is rotatably supported by the base 10 by inserting and supporting the pivot support pin P3 (FIG. 4C) with the pivot support hole 14 and the pivot support hole 51 located coaxially. In this supported state, the driven gear 53 meshes with the center axis (for example, the serration shaft) of the built-in gear mechanism of the motor unit 20, and the rotational driving force of the motor unit 20 is transmitted to the first arm 50. Further, the pivot support hole 52 of the first arm 50 is rotatably inserted and supported by the fitting pin of the slider shoe 45X in a state of being aligned with the through hole 45 of the bell crank 40. Accordingly, the other end side of the first arm 50 is rotatably supported by the bracket 30 (bell crank 40).

One end side of the second arm 60 is rotatably supported by the base 10, and the other end side of the second arm 60 is rotatably supported by the bracket 30 (bell crank 40). As illustrated in FIGS. 2, 8, and the like, the second arm 60 includes a narrow portion 61 located on a middle side of one end side and the other end side, and wide portions 62 located on one end side and the other end side. A pivot support hole 63 is bored in the wide portion 62 on the one end side of the second arm 60, and a pivot support hole 64 is bored in the wide portion 62 on the other end side of the second arm 60. As illustrated in FIGS. 2, 5, and the like, the base 10 is formed with a pivot support hole 15, and the one end side of the second arm 60 is rotatably supported by the base 10 by inserting and supporting a pivot support pin P1 (FIGS. 4B and 4C) with the pivot support hole 15 and the pivot support hole 63 located coaxially. Further, the other end side of the second arm 60 is rotatably supported by the bracket 30 (bell crank 40) by inserting and supporting a pivot support pin P2 (FIG. 4B) in a state in which the through hole (pivot support hole) 44 of the bell crank 40 is aligned with the pivot support hole 64 of the second arm 60. In this manner, the second arm 60 includes the narrow portion 61 located on the middle side of one end side and the other end side, the wide portion 62 (pivot support hole 63) located on one end side and rotatably supported by the base 10, and the wide portion 62 (pivot support hole 64) located on the other end side and rotatably supported by the bracket 30 (bell crank 40). By setting one end portion and the other end portion of the second arm 60 that are formed with the pivot support holes 63 and 64 as the wide portions 62, the same rigidity as that of the narrow portion 61 can be secured (uniform rigidity of the second arm 60 over a longitudinal direction can be secured).

A width of the first arm 50 is larger than a width of the second arm 60 over the longitudinal direction of the first arm 50 and the second arm 60. By optimally setting the widths and arm lengths of the first arm 50 and the second arm 60, the first arm 50, the second arm 60, and the window regulator 1 can be measured or smoothly driven.

As described later with reference to FIG. 10, when viewed from the upper-lower direction (vehicle upper-lower direction), at least a part of the first arm 50 overlaps a part of the second arm 60 (there is a portion at which the first arm 50 overlaps the second arm 60). Accordingly, a size (thickness) of the window regulator 1 in the vehicle width direction can be reduced. In a related-art product including the window regulator disclosed in Reference 1 described above, the main arm does not overlap the sub arm in the upper-lower direction and are separated from each other in the vehicle width direction, resulting in an increase in size (thickness) of the window regulator in the vehicle width direction.

The one end side of the first arm 50 and the one end side of the second arm 60 are rotatably supported by the base 10 in a manner of deviating in a driving direction of the bracket 30 that supports the window glass W and the vehicle width direction.

Here, as denoted by reference signs in FIG. 3, a rotation support position (rotation center) on the one end side of the first arm 50 toward the base 10 is referred to as a “pivot axis R1”, a rotation support position (rotation center) on the other end side of the first arm 50 toward the bracket 30 (bell crank 40) is referred to as a “pivot axis R2”, a rotation support position (rotation center) on the one end side of the second arm 60 toward the base 10 is referred to as a “pivot axis R3”, and a rotation support position (rotation center) on the other end side of the second arm 60 toward the bracket 30 (bell crank 40) is referred to as a “pivot axis R4”. The pivot axes R1 to R4 are different from each other, and a four-link pivot fulcrum (four-link regulator) having a parallelogram shape is formed with long sides of which a distance between the pivot axis R1 and the pivot axis R2 and a distance between the pivot axis R3 and the pivot axis R4 are equal to each other, and is formed with short sides of which a distance between the pivot axis R1 and the pivot axis R3 and a distance between the pivot axis R2 and the pivot axis R4 are equal to each other.

When the rotational driving force of the motor unit 20 is transmitted to the first arm 50 in a state in which the base 10 is fixed to the automobile (vehicle), the rotational driving force is also transmitted to the second arm 60. As a result, the bracket 30 and the window glass W are raised and lowered (driven) in the upper-lower direction (driving direction). At this time, for a fully open position, a fully closed position and an intermediate position as illustrated in FIG. 1, the long sides (the side that connects the pivot axis R1 and the pivot axis R2, and the side that connects the pivot axis R3 and the pivot axis R4) of the four-link pivot fulcrum are parallel to each other, the short sides (the side that connects the pivot axis R1 and the pivot axis R3, and the side that connects the pivot axis R2 and the pivot axis R4) of the four-link pivot fulcrum are parallel to each other, and the first arm 50 and the second arm 60 do not intersect each other (only angles of the parallelogram change). The first arm 50 directly transmits the rotational driving force of the motor unit 20 and mainly functions to raise and lower the window glass W, and in this sense, the first arm 50 may be referred to as the main arm. The second arm 60 indirectly transmits the rotational driving force of the motor unit 20 and subsidiarily functions to raise and lower the window glass W (also has a function of rotation prevention to be described later), and in this sense, the second arm 60 may be referred to as the sub arm. In any case, the motor unit 20 functions as a “driving member” that raises and lowers (drives) the bracket 30 supporting the window glass W by rotationally driving (directly driving) the first arm 50 with respect to the base 10 and the bracket 30 and rotationally driving (subsidiarily driving) the second arm 60 with respect to the base 10 and the bracket 30.

In the related-art window regulator, there is a problem that a force in a rotational direction is applied to the window glass and causes the window glass to rotate at or near a top dead center of the window glass. This phenomenon is caused by an insufficient length of a glass end, and is further a problem in a front door in which the length of the glass end tends to be short (it is less likely to be a problem in a rear door in which the length of the glass end is easily secured).

As a type of related-art window regulator, a single-arm type window regulator and an X-arm type window regulator are known. However, especially when the single-arm type window regulator is applied to a windshield, the single-arm type window regulator cannot completely solve the problem that the force in the rotational direction is applied to the windshield and causes the windshield to rotate. On the other hand, although the X-arm type window regulator can attain a certain effect of preventing the rotation of the window glass, the X-arm type window regulator has a complicated structure and a large size, and also tends to cause a cost increase.

Therefore, in the window regulator 1 according to the present embodiment, the four-link pivot fulcrum (four-link regulator) is attained by the base 10, the bracket 30, the first arm 50, and the second arm 60. At or near the top dead center of the window glass W, the force that causes the window glass W to rotate forward is received by cooperation between the second arm 60 and the first arm 50 (the window glass W is prevented from falling forward). More specifically, while the first arm 50 plays a main role of raising and lowering the bracket 30 (window glass \A/), the second arm 60 that is supported by the bell crank 40 directly below the first arm 50 receives, by subsidiarily supporting the first arm 50, a force that causes the window glass W to rotate forward at or near the top dead center of the window glass W (the window glass W is prevented from falling forward). The four-link regulator according to the present embodiment has advantages of simple structure, small size, and low costs as compared with the X-arm type window regulator.

In the window regulator 1 according to the present embodiment, in the assembled (sub-assembled) state before being incorporated into the automobile (vehicle), the four-link pivot fulcrum (four-link regulator) is formed in which one end sides of the first arm 50 and the second arm 60 are rotatably supported by the base 10 at different positions and the other end sides of the first arm 50 and the second arm 60 are rotatably supported by the bracket 30 (bell crank 40) at different positions. Therefore, the attachment to the automobile (vehicle) can be simplified (a structure or process of the attachment can be simplified and the number of man-hours or variations can be reduced). More specifically, the attachment of the window regulator 1 to the automobile (vehicle) is completed simply by inserting four fastening members (not illustrated) into the four insertion holes 11 of the base 10 and fastening (fastening together) the four fastening members to the door panel. In addition, it is only necessary to support the window glass W by the bracket 30 at an appropriate timing. On the other hand, in Reference 1 described above, since the sub arm is swingably provided on the side beam disposed on an inner side of a door outer panel, the number of man-hours or variations in the attachment to the automobile (vehicle) increases.

As illustrated in FIGS. 2, 4B, 6B, 6C, and the like, the base 10 includes sidewall portions 16 extending in the vehicle width direction and a second support flat-surface portion 17 connected to the sidewall portions 16. The sidewall portions 16 and the second support flat-surface portion 17 have a U shape in which end portions, on the vehicle exterior side, of a pair of sidewall portions 16 extending in the vehicle width direction are connected to each other by the second support flat-surface portion 17 in a cross-sectional view. The pivot support hole 15 is bored in the second support flat-surface portion 17. As illustrated in FIGS. 1 to 3, 5, 6B, and the like, the base 10 has a first support flat-surface portion 18 located around the pivot support hole 14 (the pivot support hole 14 is bored in the first support flat-surface portion 18).

In this manner, the base 10 includes the first support flat-surface portion 18 (pivot support hole 14) by which the one end side of the first arm 50 is rotatably supported, and the second support flat-surface portion 17 (pivot support hole 15) by which the one end side of the second arm 60 is rotatably supported. The first arm 50 of which the one end side is supported by the first support flat-surface portion 18 (pivot support hole 14), and the second arm 60 of which the one end side is supported by the second support flat-surface portion 17 (pivot support hole 15) are offset in the vehicle width direction. As illustrated in FIG. 6B, the first support flat-surface portion 18 and the second support flat-surface portion 17 are slightly offset in the vehicle width direction. The first arm 50 and the second arm 60 are each gently bent in the vehicle width direction from the rotation support portion on one end side to the rotation support portion on the other end side. However, even in consideration of this bending degree, the first support flat-surface portion 18 and the second support flat-surface portion 17 are offset in the vehicle width direction from the rotation support portion on the one end side to the rotation support portion on the other end side. Accordingly, the first arm 50 and the second arm 60 are prevented from interfering with each other during rotation (pivoting movement), the first arm 50 and the second arm 60 are prevented from interfering with other components (including being sandwiched between the two arms), and smooth operations with improved layout efficiency can be attained.

When a plate surface position at which the four insertion holes 11 are formed is set as a reference surface of the base 10, rigidity of a portion (near the pivot axis R1) that supports one end portion of the first arm 50 is secured by forming the first support flat-surface portion 18 in a shape protruding from the reference surface in a dome shape in the vehicle width direction. Further, in order to secure rigidity of a portion (near the pivot axis R3) that supports one end portion of the second arm 60 as well, a support position of the second arm 60 is not that far from a support position of the first arm 50. Therefore, the pair of sidewall portions 16 and the second support flat-surface portion 17 are formed in a shape (see FIG. 5) of extending in a radial direction from the dome-shaped portion (a foot portion of the first support flat-surface portion 18) described above. Accordingly, the base 10 is easily manufactured by pressing, and an offset amount of the two support flat-surface portions 17 and 18 in the vehicle width direction is also easily managed. In this manner, in a side view in FIG. 5, the pair of sidewall portions 16 extend in an outer diameter direction of the first support flat-surface portion 18.

By rotatably supporting the one end side of the second arm 60 by the second support flat-surface portion 17 (pivot support hole 15) that forms a connection portion having a U-shaped cross section, a position of a rotation support axis (pivot support pin P1) in the vehicle width direction can be appropriately set (adjusted) and high rigidity of the connection portion between the second arm 60 and the base 10 can be maintained. In Reference 1 described above, since the main arm and the sub arm are supported in a state of being separated from each other in the vehicle width direction, rigidity of arm members is insufficient, resulting in deterioration in accuracy or variation in assembly.

The window regulator 1 according to the present embodiment is a four-link window regulator in which the one end side of the first arm 50 and the one end side of the second arm 60 are rotatably supported by the base 10, and in which the other end side of the first arm 50 and the other end side of the second arm 60 are rotatably supported by the bracket 30 (bell crank 40) (four rotation support positions are different). In addition, as illustrated in FIGS. 1 to 3 and the like, a rotation center axis on the one end side of the first arm 50 deviates from a rotation center axis on the one end side of the second arm 60 in the driving direction (upper-lower direction) of the bracket 30 that supports the window glass W, and a rotation center axis on the other end side of the first arm 50 deviates from a rotation center axis on the other end side of the second arm 60 in the driving direction (upper-lower direction) of the bracket 30 that supports the window glass W.

In FIG. 3, when a focus is given to a positional relationship between the pivot axis R1 and the pivot axis R3, the pivot axis R1 and the pivot axis R3 are largely offset in the upper-lower direction, are (almost) not offset in the front-rear direction, and are offset in the vehicle width direction to an extent of preventing interference between the first arm 50 and the second arm 60. Similarly, when a focus is given to a positional relationship between the pivot axis R2 and the pivot axis R4, the pivot axis R2 and the pivot axis R4 are largely offset in the upper-lower direction, are (almost) not offset in the front-rear direction, and are offset in the vehicle width direction to the extent of preventing the interference between the first arm 50 and the second arm 60. As illustrated in FIG. 1, the positional relationship between the pivot axis R1 and the pivot axis R3 and the positional relationship between the pivot axis R2 and the pivot axis R4 are normally kept the same regardless of pivot positions (opening degree position of the window glass \N) of the first arm 50 and the second arm 60. Accordingly, the first arm 50 and the second arm 60 do not overlap (intersect) each other during the pivoting movement. As a result, a local force (a force that causes deformation) can be prevented from being applied to the first arm 50 and the second arm 60.

In Reference 1 described above, the rotation support portions on one end sides of the main arm and the sub arm are offset only in the vehicle front-rear direction (positions in the upper-lower direction are the same), and the rotation support portions on the other end sides of the main arm and the sub arm are offset only in the vehicle front-rear direction (positions in the upper-lower direction are the same). Since the main arm and the sub arm overlap (intersect) each other during the pivoting movement, a local force (a force that causes deformation) is applied to the main arm and the sub arm. More specifically, since moment arms applied to the overlapped (intersected) main arm and sub arm are infinite, a load applied to the sub arm increases particularly, which leads to an increase in a size of the sub arm (there is no choice but to increase the size).

The window glass W is fixed to the bracket 30 by two fastening members (not illustrated) that are each inserted into a respective one of the two insertion holes 31. When the window glass W is rotated, a rotation axis of the window glass W generates a moment caused by a positional relationship between the pivot axis R1 and the pivot axis R4 in FIG. 3. In particular, in order to stop (inhibit) a rotational moment M starting from the pivot axis R2, a force P in a direction in which the second arm 60 is pulled due to the bell crank 40 is required. The force P is expressed by P=M/L, where L is a distance between the long sides of the four-link pivot fulcrum (four-link regulator). In Reference 1 described above, L=0 at a timing when the main arm overlaps (intersects) the sub arm and the force P is infinite. As a result, the local force (the force that causes deformation) is applied to the main arm and the sub arm. In this regard, in the window regulator 1 according to the present embodiment, since the distance L between the long sides of the four-link pivot fulcrum (four-link regulator) is normally constant, the force P is maintained to an extent that rotation of the window glass W can be prevented, and the local force (the force that causes deformation) can be prevented from being applied to the first arm 50 and the second arm 60. Further, the window regulator 1 (window glass W) can be stably driven.

The bracket 30 includes the bell crank 40 that is slidable in the extending direction (front-rear direction) of the slide rail 32 of the bracket 30, and the other end side of the first arm 50 and the other end side of the second arm 60 are rotatably supported by the bell crank 40 in a manner of deviating in the driving direction (upper-lower direction) of the bracket 30 that supports the window glass W (see the pivot axis R2 and the pivot axis R4 in FIG. 3). By rotatably supporting the other end side of the first arm 50 and the other end side of the second arm 60 in an offset state via the bell crank 40, the window regulator 1 (window glass W) can be stably driven.

The bell crank 40 is the substantially L-shaped (substantially boomerang-shaped) member including the first side 41 extending in the front-rear direction (the extending direction of the slide rail 32 of the bracket 30) and the second side 42 bent downward (the direction intersecting the extending direction of the slide rail 32 of the bracket 30) from the rear end portion of the bracket 30. The other end side of the first arm 50 is rotatably supported by the connection portion between the first side 41 and the second side 42 (pivot axis R2 in FIG. 3), and the other end side of the second arm 60 is rotatably supported by the second side 42 (pivot axis R4 in FIG. 3). An angle formed by the first side 41 and the second side 42 of the bell crank 40 may be a right angle, an acute angle, or an obtuse angle, and is preferably, for example, 80° or more and 100° or less in order to attain an offset between the pivot axis R2 and the pivot axis R4 in the upper-lower direction. In particular, by setting the angle formed by the first side 41 and the second side 42 of the bell crank 40 to be an acute angle (for example, 80° or more and less than 90°), input of a load to the first arm 50 and the second arm 60 can be reduced (a difference in the input load is reduced) at and near the top dead center of the window glass W and at and near a bottom dead center of the window glass W.

In the window regulator 1 according to the present embodiment, in a movable range of the first arm 50, a line segment (line segment connecting the pivot axis R1 and the pivot axis R2) connecting the rotation center on the one end side of the first arm 50 and the rotation center on the other end side of the first arm 50 does not overlap the rotation center (pivot axis R3) on the one end side of the second arm 60 and the rotation center (pivot axis R4) on the other end side of the second arm 60. Accordingly, damage to the window regulator 1 can be prevented within the movable range of the first arm 50, and the window regulator 1 (window glass W) can be stably driven.

In the window regulator 1 according to the present embodiment, when the window glass W is located at the bottom dead center, a deviation amount between the rotation support portion (pivot axis R1) on the one end side of the first arm 50 and the rotation support portion (pivot axis R3) on the one end side of the second arm 60 in the driving direction (upper-lower direction) and a deviation amount between the rotation support portion (pivot axis R2) on the other end side of the first arm 50 and the rotation support portion (pivot axis R4) on the other end side of the second arm 60 in the driving direction (upper-lower direction) are smaller than a distance between the rotation center (pivot axis R2) on the other end side of the first arm 50 and a lower surface of a vehicle door panel. Accordingly, even when the window glass W is located at the bottom dead center, interference with the vehicle door panel can be prevented, and the window regulator 1 (window glass \N) can be stably driven.

In the window regulator device according to Reference 1 described above, there is a problem that an undesirable force acts on the window glass due to a deviation between a raising and lowering trajectory of the window glass and driving trajectories of the main arm and the sub arm, and that smooth raising and lowering is inhibited. This problem is caused by, in addition to a fact that the main arm and the sub arm draw linear trajectories while the window glass and a door frame draw a trajectory having a curvature, a fact that each rotation center axis (rotation support axis) of the main arm and the sub arm are oriented in the vehicle width direction. A pulling force based on the bending of the main arm and the sub arm acts when the window glass is raised and lowered, or a pushing force is generated when the window glass is closed.

The window regulator 1 according to the present embodiment solves the above problem, and prevents the action of force on the window glass W and attains smooth driving by bringing the driving trajectories of the window glass W and the arm members (first arm 50 and second arm 60) close to each other. Therefore, at least one of the rotation center axes on the one end sides of the arm members (first arm 50 and second arm 60) and the rotation center axes on the other end sides of the arm members is inclined in the front-rear direction (vehicle front-rear direction) with respect to the vehicle width direction when viewed from the upper-lower direction (vehicle upper-lower direction). More specifically, at least one of the rotation center axis (pivot axis R1) on the one end side of the first arm 50, the rotation center axis (pivot axis R2) on the other end side of the first arm 50, the rotation center axis (pivot axis R3) on the one end side of the second arm 60, and the rotation center axis (pivot axis R4) on the other end side of the second arm 60 is inclined in the front-rear direction (vehicle front-rear direction) with respect to the vehicle width direction when viewed from the upper-lower direction (vehicle upper-lower direction).

At least one of the rotation center axes on the one end sides of the arm members (first arm 50 and second arm 60) and the rotation center axes on the other end sides of the arm members is inclined toward the vehicle front-rear direction (front side or rear side) as advancing in a vehicle exterior direction when viewed from the upper-lower direction. More specifically, at least one of the rotation center axis (pivot axis R1) on the one end side of the first arm 50, the rotation center axis (pivot axis R2) on the other end side of the first arm 50, the rotation center axis (pivot axis R3) on the one end side of the second arm 60, and the rotation center axis (pivot axis R4) on the other end side of the second arm 60 is inclined toward the vehicle front-rear direction (front side or rear side) as advancing in the vehicle exterior direction when viewed from the upper-lower direction.

As illustrated in FIG. 10, the one end side of the first arm 50 is supported rotatably about the rotation center axis (pivot axis R1) with respect to the base 10. When viewed from the upper-lower direction, the rotation center axis (pivot axis R1) is inclined toward the vehicle front-rear direction (front side) as advancing in the vehicle exterior direction. The one end side of the second arm 60 is supported rotatably about the rotation center axis (pivot axis R3) with respect to the base 10. When viewed from the upper-lower direction, the rotation center axis (pivot axis R3) is inclined toward the vehicle front-rear direction (front side) as advancing in the vehicle exterior direction. In FIG. 10, since the pivot axes R1 and R3 overlap in the upper-lower direction, the pivot axes R1 and R3 are illustrated by a single axis.

As illustrated in FIG. 10, the other end side of the first arm 50 is supported rotatably about the rotation center axis (pivot axis R2) with respect to the bracket 30 (bell crank 40). When viewed from the upper-lower direction, the rotation center axis (pivot axis R2) is inclined toward the vehicle front-rear direction (rear side) as advancing in the vehicle exterior direction. The other end side of the second arm 60 is supported rotatably about the rotation center axis (pivot axis R4) with respect to the bracket 30 (bell crank 40). When viewed from the upper-lower direction, the rotation center axis (pivot axis R4) is inclined toward the vehicle front-rear direction (rear side) as advancing in the vehicle exterior direction. In FIG. 10, since the pivot axes R2 and R4 overlap in the upper-lower direction, the pivot axes R2 and R4 are illustrated by a single axis.

At least one of the rotation center axes on the one end sides of the arm members (first arm 50 and second arm 60) and the rotation center axes on the other end sides of the arm members is inclined forward in the vehicle front-rear direction as advancing in the vehicle exterior direction when viewed from the vehicle upper-lower direction in a case in which the rotation center axis on the other end side is located rearward of the rotation center axis on the one end side in the vehicle front-rear direction, and is inclined rearward in the vehicle front-rear direction as advancing in the vehicle exterior direction when viewed from the vehicle upper-lower direction in a case in which the rotation center axis on the other end side is located forward of the rotation center axis on the one end side in the vehicle front-rear direction.

Regarding inclination degrees of the pivot axis R1 to the pivot axis R4, assuming curvatures of general window glass and a door frame, when the window glass and the door frame are rotated forward or rearward by about 10° with reference to the vehicle width direction, an operation that matches (follows) the curvatures of the window glass and the door frame is enabled. However, regarding the inclination degrees of the pivot axis R1 to the pivot axis R4, various design changes can be made according to the curvatures of the window glass and the door frame (for example, even if an inclination angle smaller than the most preferable inclination angle is set, a certain effect can be attained). Although a wire-type regulator has an advantage that it is easy to follow a raising and lowering trajectory of the window glass, the window regulator 1 according to the present embodiment has advantages that the window regulator 1 can follow the raising and lowering trajectory of the window glass at a level equivalent to that of the wire-type regulator while employing the four-link pivot fulcrum (four-link regulator).

By reducing the generation of the force applied to the window glass W in the vehicle width direction due to the inclination of the rotation center axis (pivot axis) described above, the action of the pulling force generated by the first arm 50 and the second arm 60 when the window glass W is raised and lowered can be prevented, the generation of the pushing force when the window glass W is closed can be prevented, and the window glass W can be smoothly raised and lowered (driven). The rotation of the window glass W can be prevented by the four-link pivot fulcrum (four-link regulator).

As illustrated in FIG. 10, the first arm 50 has a relatively large inclination degree with respect to the vehicle front-rear direction at the rotation support portion (rotation center axis or the vicinity thereof) on the one end side and the rotation support portion (rotation center axis or the vicinity thereof) on the other end side, and has a relatively small inclination degree with respect to the vehicle front-rear direction on the middle side of the one end side and the other end side. For example, from the front side toward the rear side, the first arm 50 may be inclined toward the vehicle exterior side in a relatively steep manner in the vicinity of the rotation support portion on the one end side, inclined toward the vehicle interior side or the vehicle exterior side in a relatively gentle manner on the middle side of the one end side and the other end side, and inclined toward the vehicle exterior side in a relatively steep manner in the vicinity of the rotation support portion on the other end side. By optimally setting the inclination degree of the first arm 50 according to a position in the front-rear direction, a size of the first arm 50 in the vehicle width direction can be reduced, and the window regulator 1 can be disposed with high layout efficiency even in a narrow space in the door panel. The middle side may extend in the front-rear direction, and may not be inclined to the vehicle interior side or the vehicle exterior side. A case in which the inclination degree on the middle side is relatively small also includes a case in which no inclination is present.

Similarly, the second arm 60 has a relatively large inclination degree with respect to the vehicle front-rear direction at the rotation support portion (rotation center axis or the vicinity thereof) on the one end side and the rotation support portion (rotation center axis or the vicinity thereof) on the other end side, and has a relatively small inclination degree with respect to the vehicle front-rear direction on the middle side of the one end side and the other end side. For example, from the front side toward the rear side, the second arm 60 may be inclined toward the vehicle exterior side in a relatively steep manner in the vicinity of the rotation support portion on the one end side, inclined toward the vehicle interior side or the vehicle exterior side in a relatively gentle manner on the middle side of the one end side and the other end side, and inclined toward the vehicle exterior side in a relatively steep manner in the vicinity of the rotation support portion on the other end side. By optimally setting the inclination degree of the second arm 60 according to a position in the front-rear direction, a size of the second arm 60 in the vehicle width direction can be reduced, and the window regulator 1 can be disposed with high layout efficiency even in a narrow space in the door panel. The middle side may extend in the front-rear direction, and may not be inclined to the vehicle interior side or the vehicle exterior side. A case in which the inclination degree on the middle side is relatively small also includes a case in which no inclination is present.

As illustrated in FIG. 4A, when the pivot axis R2 on the other end side of the first arm 50 is inclined, a base portion of the slider shoe 45X is not inclined, smooth sliding with respect to the slide rail 32 in the front-rear direction is secured, and only a displacement support portion having a fitting pin supported on the base portion of the slider shoe 45X with play is inclined. In this manner, the slider shoe includes the base portion and the displacement support portion having the fitting pin supported on the base portion with play, so that the pivot axis can be flexibly inclined while absorbing variations in assembly.

The window regulator 1 according to the present embodiment includes the driven gear (gear member) 53 formed with the tooth portions (gear mechanism) 53X that transmit the rotational driving force of the motor unit (driving member) 20 to the arm members (first arm 50 and second arm 60). As illustrated in FIG. 10, the tooth portions 53X of the driven gear 53 are inclined in the vehicle front-rear direction with respect to the vehicle width direction when viewed from the vehicle upper-lower direction. That is, an inclination amount of the tooth portions 53X of the driven gear 53 matches an inclination amount in the vicinity of the rotation support portion (rotation center axis or the vicinity thereof) on the one end sides of the first arm 50 and the second arm 60. By optimally setting the inclination amount of the tooth portions 53X of the driven gear 53, even when the rotation center axis (pivot axis) of the arm members (first arm 50 and second arm 60) is inclined, meshing between the center axis (for example, the serration shaft) of the built-in gear mechanism of the motor unit 20 and the tooth portions 53X of the driven gear 53 can be favorably maintained.

On the other hand, the base 10 is fastened (fastened together) to the door panel by fastening members (not illustrated) that are inserted into the four insertion holes 11, and an axial direction of the fastening members (insertion holes 11) is oriented in the vehicle width direction and is not parallel to the rotation center axis on the one end side or the rotation center axis on the other end side (both inclined) of the arm members (first arm 50 and second arm 60). Accordingly, the assembly of the window regulator 1 can be simplified.

In the present embodiment, in order to prevent the action of the force on the window glass W and attain smooth driving by bringing the driving trajectories of the window glass W and the arm members (first arm 50 and second arm 60) close to each other, as illustrated in FIG. 10, the rotation center axis R1 on the one end side of the first arm 50, the rotation center axis R2 on the other end side of the first arm 50, the rotation center axis R3 on the one end side of the second arm 60, and the rotation center axis R4 on the other end side of the second arm 60 are inclined in the vehicle front-rear direction with respect to the vehicle width direction when viewed from the vehicle upper-lower direction. In this case, since the motor unit (driving member) 20 protrudes (projects) in the vehicle width direction (for example, a vehicle interior direction) due to the inclination of the rotation center axes R1 to R4, there may be a problem that the motor unit 20 interferes with the door panel (for example, the inner panel) or a layout restriction may occur.

Therefore, in the present embodiment, a “bent portion” can be provided, which prevents the motor unit (driving member) 20 from protruding in the vehicle width direction due to the inclination of at least one of the rotation center axis (R1 and R3) on the one end side of the arm members (first arm 50 and second arm 60) and the rotation center axis (R2 and R4) on the other end side of the arm members. Accordingly, the action of the force on the window glass W can be prevented, smooth driving can be attained, interference with the door panel (for example, the inner panel) can be prevented, and the layout restriction can be removed (it is not necessary to widen the space in the door panel).

FIGS. 11A and 11B are views illustrating superiority attained by the bent portion according to the present embodiment, FIG. 11A is a view illustrating a case in which the bent portion is provided, and FIG. 11B is a view illustrating a case in which the bent portion is not provided. However, a window regulator in FIG. 11B is also the same as the window regulator 1 having features according to the present embodiment only except that the bent portion is not provided. In FIG. 11B, the rotation center axes R1 to R4 are inclined, so that the driving trajectories of the window glass W and the arm members (first arm 50 and second arm 60) are brought close to each other, thereby preventing the action of the force on the window glass W and attaining smooth driving. On the other hand, due to the inclination of the rotation center axes R1 to R4, a demerit that the motor unit (driving member) 20 protrudes (projects) in the vehicle width direction (for example, the vehicle interior direction) occurs. In contrast, in FIG. 11A, the inclination of the rotation center axes R1 to R4 and functions and effects thereof remain the same, and a “bent portion” is provided, which prevents the motor unit (driving member) 20 from protruding in the vehicle width direction due to the inclination of at least one of the rotation center axis (R1 and R3) on the one end side of the arm members (first arm 50 and second arm 60) and the rotation center axis (R2 and R4) on the other end side of the arm members.

FIG. 12 is a view illustrating a detailed structure of the bent portion according to the present embodiment. As illustrated in FIG. 12, the center axis (for example, the serration shaft) 21 of the built-in gear mechanism of the motor unit (driving member) 20 is fitted into the fitting hole 12 of the base 10. The first arm 50 is provided with (connected to) the driven gear (gear member) 53, and the tooth portions 53X of the driven gear 53 mesh with the center axis (for example, the serration shaft) 21 of the motor unit 20. In this manner, the driven gear (gear member) 53 is formed with the tooth portions (gear mechanism) 53X that transmit the rotational driving force of the motor unit (driving member) 20 to the first arm (arm member) 50.

Further, as illustrated in FIG. 12, a thickness of the driven gear (gear member) 53 is set to be larger than a thickness of the first arm (arm member) 50, and the “bent portion” is formed in a region of the driven gear (gear member) 53 in which the tooth portions (gear mechanism) 53X are not formed. In FIG. 12, the region in which the “bent portion” is formed is enclosed by a circle, and the “bent portion” is denoted by a reference sign 53M. By providing the bent portion 53M in the driven gear (gear member) 53 that has a thickness larger than that of the first arm (arm member) 50, deformation or the like of the bent portion 53M can be prevented even when stress concentration occurs in the bent portion 53M. An angle of the bent portion 53M, that is, an angle formed by flat-surface portions on one side and the other side of the bent portion 53M of the driven gear (gear member) 53 has a degree of freedom, and various design changes can be made. For example, the angle can be set to 10°±3° or 10°±5°. The bending angle can be appropriately set within a range in which the motor unit (driving member) 20 can be prevented from protruding in the vehicle width direction due to the inclination of at least one of the rotation center axis (R1 and R3) on the one end side of the arm members (first arm 50 and second arm 60) and the rotation center axis (R2 and R4) on the other end side of the arm members.

FIG. 12 illustrates an example in which the bent portion 53M is provided in the driven gear (gear member) 53. Alternatively, the “bent portion” may be formed in at least one of the base 10, the first arm (arm member) 50, and the driven gear (gear member) 53. That is, all or a part of the base 10, the first arm (arm member) 50, and the driven gear (gear member) 53 may have a function of preventing the motor unit (driving member) 20 from protruding in the vehicle width direction (may cooperate with each other).

In FIG. 12, a panel attachment surface of the base (base plate) 10 is denoted by a reference sign 70, and a pierce nut (base plate pierce nut) used for the attachment surface 70 is denoted by a reference sign 71. Similarly, a panel attachment surface of the base (base plate) 10 is denoted by a reference sign 80, and a pierce nut (base plate pierce nut) used for the attachment surface 80 is denoted by a reference sign 81. An attachment axis of the pierce nut 71 is denoted by a reference sign 71R, and an attachment axis of the pierce nut 81 is denoted by a reference sign 81R. The attachment axis 71R is coaxial with the center axis (for example, the serration shaft) 21 of the motor unit 20. Alternatively, the two axes may not necessarily be coaxial, and may be disposed at an angle to each other. With reference to the pivot axis R1, an angle 81 formed by the pivot axis R1 and the attachment axis 71R of the pierce nut 71 and an angle 82 formed by the pivot axis R1 and the attachment axis 81R of the pierce nut 81 can be set to, for example, 10°±3° or 10°±5°. In other words, the “bent portion” can be set in all or a part of the base 10, the first arm (arm member) 50, and the driven gear (gear member) 53 in a manner of attaining such angles 81 and 82.

The “bent portion 53M” according to the present embodiment can also be expressed as follows. The tooth portions (gear mechanism) 53X constitute a “meshing portion” that meshes with the gear mechanism (for example, the serration shaft 21) of the motor unit (driving member) 20. The “bent portion 53M” may be formed between the rotation center axis and the “meshing portion” such that the “meshing portion” is located on a rotation center axis side when a plane is defined. The plane includes an axis fixing plane between the rotation center axis on the one end side of the first arm (arm member) 50 and the rotation center axis on the other end side of the first arm 50 and is orthogonal to the rotation center axes. That is, the “bent portion” may be provided between the axis portion and the meshing portion such that the meshing portion is located on the axis side with respect to a virtual line of the axis fixing plane.

The “bent portion” according to the present embodiment may have configurations as follows.

In a first aspect, in a case in which the driving member is located on a front side with respect to the rotation center axis of the arm member in the vehicle front-rear direction, when the tip end portion on the vehicle exterior side of the rotation center axis of the arm member is inclined forward in the vehicle front-rear direction, a “bent portion” that is bent outward (vehicle exterior side) in the vehicle width direction may be provided between the rotation center axis of the arm member and the meshing portion of the gear mechanism.

In a second aspect, in a case in which the driving member is located on the front side with respect to the rotation center axis of the arm member in the vehicle front-rear direction, when the tip end portion on the vehicle exterior side of the rotation center axis of the arm member is inclined rearward in the vehicle front-rear direction, a “bent portion” that is bent inward (vehicle interior side) in the vehicle width direction may be provided between the rotation center axis of the arm member and the meshing portion of the gear mechanism.

In a third aspect, in a case in which the driving member is located on a rear side with respect to the rotation center axis of the arm member in the vehicle front-rear direction, when the tip end portion on the vehicle exterior side of the rotation center axis of the arm member is inclined forward in the vehicle front-rear direction, a “bent portion” that is bent inward (vehicle interior side) in the vehicle width direction may be provided between the rotation center axis of the arm member and the meshing portion of the gear mechanism.

In a fourth aspect, in a case in which the driving member is located on the rear side with respect to the rotation center axis of the arm member in the vehicle front-rear direction, when the tip end portion on the vehicle exterior side of the rotation center axis of the arm member is inclined rearward in the vehicle front-rear direction, a “bent portion” that is bent outward (vehicle exterior side) in the vehicle width direction may be provided between the rotation center axis of the arm member and the meshing portion of the gear mechanism.

In any one of the first to fourth aspects, the plane from the bent portion to the meshing portion may have a conical shape.

Although this disclosure disclosed here has been described in detail above, it is obvious to those skilled in the art that this disclosure disclosed here is not limited to the embodiments described in this disclosure. This disclosure disclosed here can be corrected and modified without departing from the spirit and scope of this disclosure that are determined based on the claims. Accordingly, the description of this disclosure is intended for illustrative description and does not have any restrictive meaning to this disclosure disclosed here.

In the embodiment described above, the window regulator 1 of a power-window type is described as an example in which the first arm 50 and the second arm 60 are rotationally driven by the motor unit 20. However, this disclosure is also applicable to a manual window regulator that transmits a driving force of manual rotation to the first and second arms. That is, in a specific aspect, there is a degree of freedom for the driving member that rotationally drives the first and second arms (arm members), and various design changes can be made.

In the embodiment described above, the case is described as an example in which the other end portions of the first arm 50 and the second arm 60 are rotatably supported by the bell crank (shoe member) 40 slidably supported by the bracket 30. However, an aspect may be adopted in which the other end portions of the first and second arms are rotatably supported by a part of the bracket or another support member for the bracket.

In the embodiment described above, the case is described as an example in which the rotation support portions on the other end sides of the first arm 50 and the second arm 60 are offset in the upper-lower direction and are (almost) not offset in the front-rear direction since the other end side of the first arm 50 is rotatably supported by the connection portion between the first side 41 and the second side 42 and the other end side of the second arm 60 is rotatably supported by the second side 42. However, by rotatably supporting the other end side of the first arm 50 by the first side 41, the rotation support portions on the other end sides of the first arm 50 and the second arm 60 may be offset in both the upper-lower direction and the front-rear direction. In this case, it is also preferable that an offset amount in the upper-lower direction is larger than an offset amount in the front-rear direction.

In the embodiment described above, the four-link pivot fulcrum (four-link regulator) implemented by the base 10, the bracket 30, the first arm 50, and the second arm 60 is described as an example. However, this disclosure may be applied to a general type of window regulator that raises and lowers (drives) the window glass W by an arm member, and this disclosure may also be applied to, for example, a single-arm type window regulator or an X-arm type window regulator.

According to an aspect of this disclosure, a window regulator includes: a base assembled to a vehicle; a bracket configured to support window glass; an arm member having one end side rotatably supported by the base and the other end side rotatably supported by the bracket; and a driving member configured to drive, by rotationally driving the arm member, the bracket configured to support the window glass. At least one of a rotation center axis on the one end side of the arm member and a rotation center axis on the other end side of the arm member is inclined in a vehicle front-rear direction with respect to a vehicle width direction when viewed from a vehicle upper-lower direction.

According to this disclosure, the window regulator can be provided in which the action of the force on the window glass can be prevented and the smooth driving can be attained by bringing the driving trajectories of the window glass and the arm member close to each other by inclining the rotation center axes of the arm member.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A window regulator comprising:
a base assembled to a vehicle;
a bracket configured to support window glass;
an arm member having one end side rotatably supported by the base and the other end side rotatably supported by the bracket; and
a driving member configured to drive, by rotationally driving the arm member, the bracket configured to support the window glass, wherein
at least one of a rotation center axis on the one end side of the arm member and a rotation center axis on the other end side of the arm member is inclined in a vehicle front-rear direction with respect to a vehicle width direction when viewed from a vehicle upper-lower direction.

2. The window regulator according to claim 1, wherein
at least one of the rotation center axis on the one end side of the arm member and the rotation center axis on the other end side of the arm member is inclined forward in the vehicle front-rear direction as advancing in a vehicle exterior direction when viewed from the vehicle upper-lower direction in a case in which the rotation center axis on the other end side is located rearward of the rotation center axis on the one end side in the vehicle front-rear direction, and is inclined rearward in the vehicle front-rear direction as advancing in the vehicle exterior direction when viewed from the vehicle upper-lower direction in a case in which the rotation center axis on the other end side is located forward of the rotation center axis on the one end side in the vehicle front-rear direction.

3. The window regulator according to claim 2, wherein
the arm member has a relatively large inclination degree with respect to the vehicle front-rear direction at a rotation support portion on the one end side and a rotation support portion on the other end side, and has a relatively small inclination degree with respect to the vehicle front-rear direction on a middle side of the one end side and the other end side.

4. The window regulator according to claim 2, wherein
the arm member includes
a first arm having one end side rotatably supported by the base and the other end side rotatably supported by the bracket, and
a second arm having one end side rotatably supported by the base and the other end side rotatably supported by the bracket,
at least one of a rotation center axis on the one end side of the first arm and a rotation center axis on the other end side of the first arm is inclined in the vehicle front-rear direction with respect to the vehicle width direction when viewed from the vehicle upper-lower direction, and
at least one of a rotation center axis on the one end side of the second arm and a rotation center axis on the other end side of the second arm is inclined in the vehicle front-rear direction with respect to the vehicle width direction when viewed from the vehicle upper-lower direction.

5. The window regulator according to claim 2, further comprising:
a gear member formed with a gear mechanism configured to transmit a rotational driving force of the driving member to the arm member, wherein
the gear mechanism of the gear member is inclined in the vehicle front-rear direction with respect to the vehicle width direction when viewed from the vehicle upper-lower direction.

6. The window regulator according to claim 2, wherein
the base is fastened to a vehicle member by a fastening member, and
an axial direction of the fastening member is oriented in the vehicle width direction and is not parallel to the rotation center axis on the one end side of the arm member or the rotation center axis on the other end side of the arm member.

7. The window regulator according to claim 2, further comprising:
a bent portion configured to prevent the driving member from protruding in the vehicle width direction due to inclination of at least one of the rotation center axis on the one end side of the arm member and the rotation center axis on the other end side of the arm member.

8. The window regulator according to claim 7, further comprising:
a gear member formed with a gear mechanism configured to transmit a rotational driving force of the driving member to the arm member, wherein
the bent portion is formed in at least one of the base, the arm member, and the gear member.

9. The window regulator according to claim 8, wherein
a thickness of the gear member is set to be larger than a thickness of the arm member, and
the bent portion is formed in a region of the gear member in which the gear mechanism is not formed.

10. The window regulator according to claim 7, further comprising:
a gear member formed with a gear mechanism configured to transmit a rotational driving force of the driving member to the arm member, wherein
the gear mechanism constitutes a meshing portion configured to mesh with the gear mechanism of the driving member, and
the bent portion is formed between the rotation center axis and the meshing portion such that the meshing portion is located on a rotation center axis side when a plane is defined, the plane including an axis fixing plane between the rotation center axis on the one end side of the arm member and the rotation center axis on the other end side of the arm member and being orthogonal to the rotation center axes.

11. The window regulator according to claim 1, wherein
the arm member has a relatively large inclination degree with respect to the vehicle front-rear direction at a rotation support portion on the one end side and a rotation support portion on the other end side, and has a relatively small inclination degree with respect to the vehicle front-rear direction on a middle side of the one end side and the other end side.

12. The window regulator according to claim 1, wherein
the arm member includes
a first arm having one end side rotatably supported by the base and the other end side rotatably supported by the bracket, and
a second arm having one end side rotatably supported by the base and the other end side rotatably supported by the bracket,
at least one of a rotation center axis on the one end side of the first arm and a rotation center axis on the other end side of the first arm is inclined in the vehicle front-rear direction with respect to the vehicle width direction when viewed from the vehicle upper-lower direction, and
at least one of a rotation center axis on the one end side of the second arm and a rotation center axis on the other end side of the second arm is inclined in the vehicle front-rear direction with respect to the vehicle width direction when viewed from the vehicle upper-lower direction.

13. The window regulator according to claim 1, further comprising:
a gear member formed with a gear mechanism configured to transmit a rotational driving force of the driving member to the arm member, wherein
the gear mechanism of the gear member is inclined in the vehicle front-rear direction with respect to the vehicle width direction when viewed from the vehicle upper-lower direction.

14. The window regulator according to claim 1, wherein
the base is fastened to a vehicle member by a fastening member, and
an axial direction of the fastening member is oriented in the vehicle width direction and is not parallel to the rotation center axis on the one end side of the arm member or the rotation center axis on the other end side of the arm member.

15. The window regulator according to claim 1, further comprising:
a bent portion configured to prevent the driving member from protruding in the vehicle width direction due to inclination of at least one of the rotation center axis on the one end side of the arm member and the rotation center axis on the other end side of the arm member.

16. The window regulator according to claim 15, further comprising:
a gear member formed with a gear mechanism configured to transmit a rotational driving force of the driving member to the arm member, wherein
the bent portion is formed in at least one of the base, the arm member, and the gear member.

17. The window regulator according to claim 16, wherein
a thickness of the gear member is set to be larger than a thickness of the arm member, and
the bent portion is formed in a region of the gear member in which the gear mechanism is not formed.

18. The window regulator according to claim 15, further comprising:
a gear member formed with a gear mechanism configured to transmit a rotational driving force of the driving member to the arm member, wherein
the gear mechanism constitutes a meshing portion configured to mesh with the gear mechanism of the driving member, and
the bent portion is formed between the rotation center axis and the meshing portion such that the meshing portion is located on a rotation center axis side when a plane is defined, the plane including an axis fixing plane between the rotation center axis on the one end side of the arm member and the rotation center axis on the other end side of the arm member and being orthogonal to the rotation center axes.
